(19) United States
(12) Patent Application Publication
(10) Pub. No.: US 2013/0304738 A1
(43) Pub. Date: Nov. 14, 2013

(54) MANAGING MULTIMEDIA INFORMATION USING DYNAMIC SEMANTIC TABLES

(71) Applicants: Sandra K. Johnson, Cary, NC (US); Grant D. Miller, Superior, CO (US)

(72) Inventors: Sandra K. Johnson, Cary, NC (US); Grant D. Miller, Superior, CO (US)

(73) Assignee: International Business Machines Corporation, Armonk, NY (US)

(21) Appl. No.: 13/470,113

(22) Filed: May 11, 2012

(51) Int. Cl. G06F 17/30

(52) U.S. Cl. 707/737; 707/E17.046

(57) ABSTRACT

Systems, methods and computer program products manage collections of information using latent semantic analysis. The collections of information may be text based such as collections of documents or non-text data such as audio, image, video or multimedia data. Semantic information groups are created by grouping collections of information according to a degree of relatedness. A system allocates discontiguous node locations of one or more distributed databases to the semantic information groups. The system manages a dynamic semantic table that maps the discontiguous node locations to a semantic virtual table having a contiguous memory space.

### BACKGROUND

Embodiments of the inventive subject matter generally relate to the field of computer databases, and, more particularly, to maintaining information, including multimedia information, in dynamic semantic tables.

Databases are commonly used to store information for retrieval or processing. Databases are managed by a database management system. The database management system receives and stores data in the database. The database management system also performs queries on databases managed by the database management system to modify or retrieve particular information.

Various types of data may be stored in a database. While data in a database is often text based, other types of non-text data such as audio, image or video data. As database size grows, the speed with which the database may be queried decreases. The speed decreases because there is more data in the database that must be processed by the database management system to determine whether the row meets the criteria in the query. Additionally, a database may be a distributed database in which data may be spread across multiple processing nodes in a network of nodes that make up the distributed database.

### SUMMARY

Systems, methods and computer program products manage collections of information using latent semantic analysis. The collections of information may be text based such as collections of documents or non-text data such as audio, image, video or multimedia data. Semantic information groups are created by grouping collections of information according to a degree of relatedness. A system allocates discontiguous node locations of one or more distributed databases to the semantic information groups. The system manages a dynamic semantic table that maps the discontiguous node locations to a semantic virtual table having a contiguous memory space.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a pictorial representation of a network of data processing systems in which example embodiments may be implemented.

FIG. 2 is an illustration of a data management environment in accordance with example embodiments.

FIG. 3 an illustration of a database management process in accordance with example embodiments.

FIG. 4 is an illustration of a collection of textual information.

FIG. 5 an illustration of a concept with a singular value decomposition is depicted in accordance with an example embodiment.

FIG. 6 illustrates collections of information associated with a database table on a semantic node

FIG. 7 illustrates the placement of collections of information in one or more semantic groups.

FIG. 8 illustrates the association of a concept with content.

FIG. 9 illustrates a structure that may be used to represent a semantic group.

FIG. 10 is a flowchart that illustrates a method for mapping discontiguous node locations to contiguous memory locations according to embodiments.

FIG. 11 is a block diagram illustrating mapped entities using a dynamic virtual mapping table.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

Database design is often defined by laying out tables of fields that have a defined taxonomy and are normalized. Views can the be created based on the attributes of the stored data, but the underlying taxonomy is still pre-defined and maintained. The invention uses semantics and semantic relationships to define the layout of the table. By this we mean that the words used, and their meaning define a space that is used to define relationships to other like words. This distance vector between members of the space can be adjusted to contract or expand the space. The space then becomes the table and contains like or related entities.

In some embodiments, the elements of the semantic table are multimedia objects that do not have directly contained text, but rather text that can be inferred about the object (e.g. video, audio, etc.). It is these inferences that are then semantically organized as described above.

Searching often is done to find results that are related to a particular query. Storing information, or media, in a semantic table enables the quick and efficient discovery of related items.

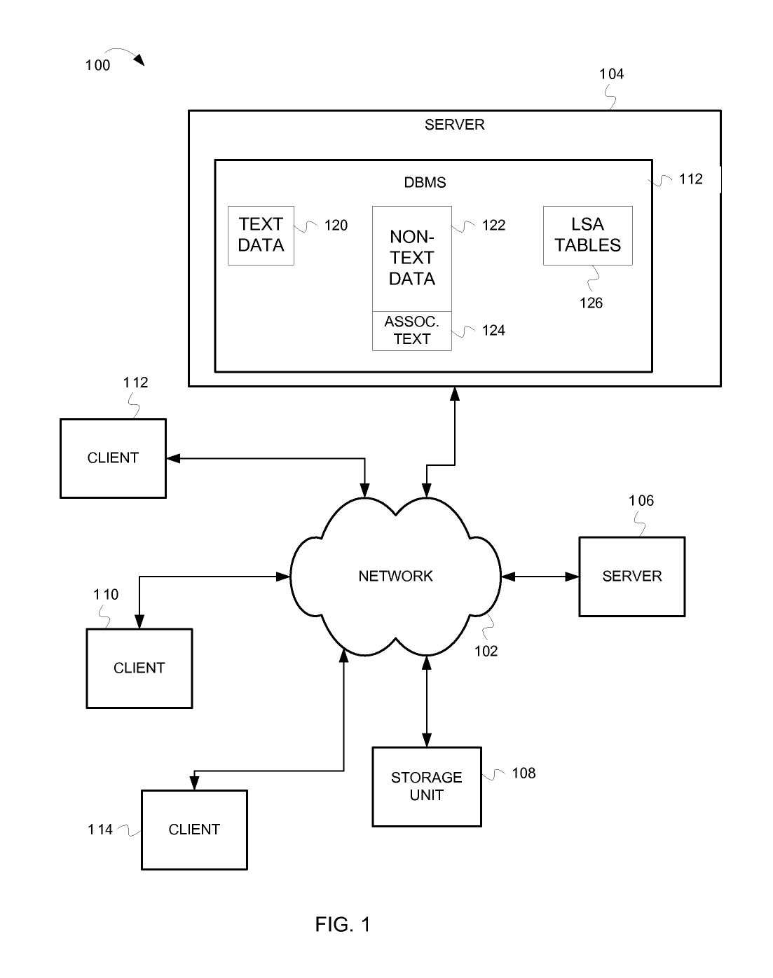

With reference now to the figures and in particular with reference to FIG. 1, an illustrative diagram of a data processing environment is provided in which example embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which example embodiments may be implemented. Network data processing system 100 is a network of computers in which the example embodiments may be implemented. Network data processing system 100 contains network 102, which is the medium used to provide communications links between various devices and computers connected together within network data processing system 100. Network 102 may include connections, such as wire, wireless communication links, or fiber optic cables. Further, network 102 maybe a combination of various networks.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 may be clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In some embodiments, network data processing system 100 is the Internet with network 102 representing a worldwide collection of networks and gateways that use the Transmission Control Protocol/Internet Protocol (TCP/IP) suite of protocols to communicate with one another. Included in the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different example embodiments.

Computers in network data processing system 100, such as client computer 110 and server computer 104, implement example embodiments to manage information. In these examples, a client computer, such as client computer 110, connects to a server computer, such as server computer 104. Client computer 110 then requests that information be stored in a database accessible to server computer 104. Server computer 104 runs a database management system 112. A database management system is software that stores data in a database and retrieves data from the database in response to a query for data matching particular criteria.

Server computer 104 receives the request containing the information from client computer 110 and performs a latent semantic analysis on the collections of information in the database and the information in the request. In some cases, the latent semantic analysis may have been done on an existing collection, in which case the resulting matrices are used in the calculation. In these examples, each collection of information is stored as a table in the database. Each table in the database is also associated with at least one concept. A concept is a topic for a table that describes the contents of the table.

The collections in the database may be text data 120 or non-text data 122. Generally speaking, text data may comprise documents or other data that is primarily textual in nature. Non-text data 122 comprises data for object that are primarily non-textual in nature. Such data may include audio data, image data, video data, multimedia data or other data that is primarily non-textual. Non-text data 122 may have associated text 124. Associated text 124 is text data that is either included along with the non-text data 122 or text data that can be derived from the non-text data. As an example, associated text 124 may be a tag or other metadata that is associated with non-text data 122. Alternatively, associated text 124 may be text that results from optical character recognition of non-text data 122 or other processing performed on non-text data 122 that provides text data as a result.

Latent semantic analysis (abbreviated as “LSA”) is a process that identifies patterns in the relationships between the terms contained in a collection of text or in the text associated with objects in a database. Latent semantic analysis uses the principle that words that are used in the same contexts in the text tend to have similar meanings Latent semantics is used to analyze the relationships between a set of documents or objects, the terms they contain. This is done by generating a set of concepts related to the terms. Latent semantic analysis can generate one or more concepts from a collection of text in documents or objects. The one or more concepts are terms in the collection of text that are determined by the latent semantic analysis to represent the topic of the collection of text. In some embodiments, the terms are inferred from media objects via explicit or implicit tags.

LSA tables 126 are tables that are automatically created and maintained during latent semantic analysis that is performed with respect to the collections of text and non-text data in the database. LSA tables 126 contain data that is used to relate text data 120 and non-text data 122 according to concepts.

Thus, server computer 104 performs a latent semantic analysis on the information and the concept for each of the tables in the database to generate a degree of relatedness between the information from the request and each of the tables in the database. A request may be a request to store new content into the database, or a request to compare against content stored in the database. The degree of relatedness is a numeric value that represents how closely the information in the request is related to the particular concept. For example, “orange” has a higher degree of relatedness to “color” than “door.”

Once the degree of relatedness is generated between the information in the request and the concept for each of the tables in the database, server computer 104 identifies the table in the database that has a concept that is within a specified degree of relatedness with the concept for the information in the request. If a table is identified, server computer 104 then associates the information in the request with the table having the concept with the highest degree of relatedness to the information in the request. In some example embodiments, server computer 104 associates the information with the table by adding a row to the table containing the information. If no table is identified as having a concept that is related to the information in the request within the specified degree of relatedness, a new table is created to contain the information. In some example embodiments, server computer 104 then associates one or more concepts for the information with the table.

In some example embodiments, the tables are stored in a hierarchy. In example embodiments in which the tables are stored in a hierarchy, server computer 104 compares the degree of relatedness between the information in the request and the concept for each of the tables at a first level of the hierarchy and identifies the table having a concept with a degree of relatedness that exceeds a specified degree of relatedness at the particular level of the hierarchy.

Server computer 104 then performs a latent semantic analysis on the information in the request and the concept for each of the tables at the second level of the hierarchy that are directly subordinate to the table at the first level of the hierarchy. Server computer 104 then identifies the table at the second level of the hierarchy that has a degree of relatedness that exceeds a specified degree of relatedness between the information and the concept for the table, as well as a higher degree of relatedness between the information and the concept for the table at the second level of the hierarchy than the degree of relatedness between the information and the concept for the superior table at the first level of the hierarchy.

The different example embodiments recognize and take into account a number of different considerations. For example, the different example embodiments recognize and take into account that creating groups of information from a data source, such as a table in a database, that are related within a particular degree of relatedness decreases the time used to perform a query for data in the data source. The time used to perform the query is decreased because the query is directed at tables containing records that are closely related to the search terms in the query, and therefore, likely to be in the result set for the query are processed. Additionally, tables containing records that are not closely related to the search terms in the query are not processed.

The different example embodiments also recognize that creating tables for text that is not within a particular degree of relatedness of a concept of another table in the database reduces administration costs for a database because the configuration of the database may be altered without a human to identify a favorable alteration and make the alteration in the database.

Additionally, the database management system may reconfigure the database by reanalyzing data already stored in the database. In other words, the database management system may identify a collection of information in the database, based on text in the data or text associated with the data, that has a concept that has at least a particular degree of relatedness to information already stored in the database using a latent semantic analysis. The database management system may then remove the existing association for the information and create a new association for the information with the collection of information identified as having the particular degree of relatedness. In these examples, the database management system may remove the existing association and create the new association by removing the text from one table and inserting the text into another table. The reconfiguration of the database for data already stored in the database may be performed in response to a particular occurrence, such as a period of time, a number of database transactions, or an amount of disk space used by the database.

The different example embodiments also recognize and take into account that available system resources may have an effect on the length of time for performing latent semantic analysis on the text and the concepts for the collections of information. When a small number of system resources are available, the semantic analysis may take longer than when a large number of system resources are available. For example, system resources may include processor and memory availability. The different example embodiments recognize and take into account that using a degree of relatedness that corresponds to the number of available system resources reduces the amount of time taken to store the data in the database when few system resources are available. However, the degree of relatedness that corresponds to the number of available system resources may be increased when many system resources are available. The text is associated with a collection of information that is more related to the text when many system resources are available.

Thus, the different example embodiments provide a method, a computer program product, and an apparatus for managing information. A collection of information in the database having a first concept that is related to a second concept for based on text in the data or associated with the data within a degree of relatedness is identified by a processing unit. The text is associated with the collection of information identified as being related to the text within the degree of relatedness by the processing unit.

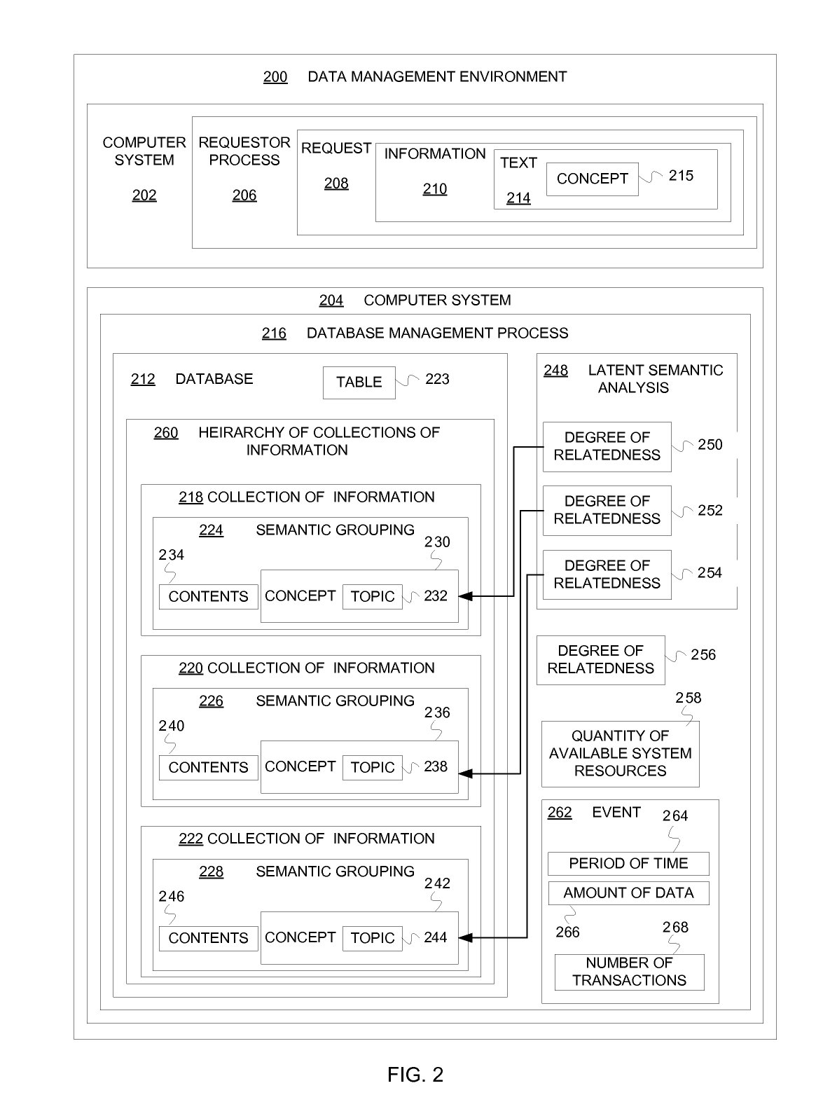

FIG. 2 is an illustration of a data management environment in accordance with example embodiments. Data management environment 200 may be implemented in network data processing system 100 using client computer 110 and server computer 104 in FIG. 1. Of course, data management environment 200 may include additional client computers, server computers, and/or other suitable components.

Data management environment 200 contains computer system 202 and computer system 204. Computer system 202 is an example implementation of client computer 110 in FIG. 1. Computer system 204 is an example implementation of server computer 104 in FIG. 1. In these examples, computer system 202 and/or computer system 204 consist of a number of computers. A “number of computers” means “one or more computers”. Computer system 202 runs requestor process 206. Requestor process 206 is a software component that generates request 208 to store information 210 in table 223 in database 212 on computer system 204. For example, requestor process 206 may be a standard query language (SQL) client application. Information 210 may include text data or non-text data. In these examples, text 214 may be the text itself in text based data. Alternatively, text 214 may be text associated or derived from non-text data. As an example of text based data, request 208 may be a request to store the word “orange” in database 212. Of course, request 208 may also be a request to store a document or a larger quantity of text than one word. Alternatively, request 208 may be a request to store audio, image, video or other non-text data. Thus Information 210 may comprise a combination of text and non-text data. For example, information 210 may be audio data, image data, or other non-textual data that has text data associated with the non-textual data. Such associated text data may be tags describing the audio or image data, names of objects in the data, locations where the data was obtained, owners of the data, or any other text data that may be associated with the non-textual data. Further, the text data may be derived from the non-textual data. As an example, speech-to-text algorithms may convert audio data to text data. Similarly, optical character recognition techniques may be used to convert image data to text data.

Computer system 202 transmits request 208 and request 208 is received by computer system 204. Request 208 may be transmitted over a network, a direct connection between computer system 204 and computer system 202, or another suitable method of communication. Computer system 204 runs database management process 216. Database management process 216 manages database 212. In other words, database management process 216 stores data in database 212, processes queries for data stored in the database, and modifies configuration parameters of database 212.

Database 212 contains collections of information 218, 220 and 222. Collections of information 218, 220, and 222 are tables in database 212 in these examples. Collections of information 218, 220, and 222 may contain groupings of text or non-text data contained in table 223. More specifically, collection of information 218 is a database table representing semantic grouping 224, collection of information 220 is a database table representing semantic grouping 226, and collection of information 222 is a database table representing semantic grouping 228.

Semantic grouping 224 is a collection of information that is related by text in table 223. As noted above, the text may be text from the text data or it may be text associated with non-textual data. First text is related to second text when the first text and the second text may be described using a concept that describes both the first text and the second text. In some example embodiments, text is contained in semantic grouping 224 when first text is synonymous with second text in semantic grouping 224. Text is synonymous with other text when both the text and the other text describe the same idea. For example, “doctors” is synonymous with “physicians,” because both words describe the idea of the profession of diagnosing and curing illness.

However, both first text and second text may not be contained in semantic grouping 224 when the first text and the second text are the same word but have a different meaning For example, “tree,” as used in the context of a plant, may not be in semantic grouping 224 when semantic grouping 224 contains “tree,” as used in the context of the computer science programming data structure. Semantic grouping 226 is a collection related by text in or associated with collection of information 220, and semantic grouping 228 is a collection related by text in or associated with collection of information 222.

Semantic grouping 224 is described by concept 230. Concept 230 is text consisting of topic 232 for contents 234 of semantic grouping 224. In other words, concept 230 describes the idea that relates contents 234 of semantic grouping 224. Likewise, semantic grouping 226 is described by concept 236. Concept 236 is text consisting of topic 238 for contents 240 of semantic grouping 226. Concept 230 describes the idea that relates contents 240 of semantic grouping 226. Additionally, semantic grouping 228 is described by concept 242. Concept 242 is text consisting of topic 244 for contents 246 of semantic grouping 228. Concept 242 describes the idea that relates contents 246 of semantic grouping 228. For example, concept 242 may be “colors” when contents 246 contain “orange”, “blue”, and “green.”

Database management process 216 generates concept 215 for text 214. Database management process 216 generates concept 215 by identifying a topic that describes the contents of text 214. Database management process 216 then performs latent semantic analysis 248 between concept 215 and each of concept 230, 236, and 242. Latent semantic analysis is an algorithm that identifies patterns in the relationships between the terms contained in a collection of text. Latent semantic analysis uses the principle that words that are used in the same contexts in the text tend to have similar meanings For example, latent semantic analysis 248 may be performed by using singular value decomposition (SVD). Computer system 204 performs latent semantic analysis 248 on concept 215 and concepts 230, 236, and 242 to generate degrees of relatedness 250, 252, and 254. Degree of relatedness 250 is a numeric value that represents how closely concept 215 is related to concept 230. Likewise, degree of relatedness 252 is a numeric value that represents how closely concept 215 is related to concept 236, and degree of relatedness 254 is a numeric value that represents how closely concept 215 is related to concept 242.

Computer system 204 running database management process 216 then determines which of degrees of relatedness 250, 252, and 254 meet or exceed degree of relatedness 256. Degree of relatedness 256 is a value configured in database management process 216 that represents the minimum degree for concept 215 to be considered related to concept 230, 236, or 242. In some example embodiments, degree of relatedness 256 is configured by a user.

However, in other example embodiments, degree of relatedness 256 is configured and updated by database management process in response to changes in quantity of available system resources 258. More specifically, database management process 216 increases degree of relatedness 256 as quantity of available system resources 258 on computer system 204 increases, and database management process 216 decreases degree of relatedness 256 as quantity of available system resources 258 on computer system 204 decreases. In such example embodiments, a user may configure maximum and minimum values for degree of relatedness 256. Database management process 216 increases or decreases degree of relatedness 256 because latent semantic analysis 248 uses more system resources to identify a greater degree of relatedness than a lesser degree of relatedness.

In some example embodiments, database management process 216 stores text 214 in table 223. Additionally, database management process 216 associates text 214 with the collection among collection of information 218, 220, and 222 with a degree of relatedness that meets or exceeds degree of relatedness 256. In these examples, database management process 216 associates text 214 with the collection by storing text 214 in the table representing the collection, such as collection of information 218. In another example, none of collections of textual information 218, 220, and 222 meet or exceed degree of relatedness 256. In such an example, database management process 216 creates an additional collection of information to contain text 214. Concept 215 is used as the concept for the new collection of information.

In other example embodiments, however, collections of information 218, 220, and 222 are stored in hierarchy of collections of information 260. Hierarchy of collections of information 260 is an ordering of collections of information 218, 220, and 222 such that particular collections may be subordinate to another collection. For example, collection of information 222 is subordinate to collection of information 220. Collection of information 222 is subordinate to collection of information 220 because concept 242 is a subcategory of concept 236. For example, concept 236 may be “medical professionals,” and concept 242 may be “doctors.”

In some example embodiments, database management process 216 monitors for the occurrence of event 262. When event 262 occurs, database management process 216 reorganizes database 212 by deleting collections of information 218, 220, and 222, and generating new collections of information from the text in table 223. In other words, database management process 216 generates concepts for the words in table 223, performs latent semantic analysis 248 on the words and any existing collections of information, and associates the text in table 223 with a collection of information that meets or exceeds degree of relatedness 256. In such example embodiments, database management process 216 may regroup information into different collections with a higher or lower degree of relatedness based on text in the information or text associated with the information. Event 262 may be period of time 264, amount of data 266 in table 223, or number of transactions 268 for database 212.

The illustration of computer system 202 and computer system 204 in data management environment 200 is not meant to imply physical or architectural limitations to the manner in which different features may be implemented. Other components in addition to and/or in place of the ones illustrated may be used. Some components may be unnecessary in some example embodiments. Also, the blocks are presented to illustrate some functional components. One or more of these blocks may be combined and/or divided into different blocks when implemented in different example embodiments.

For example, in example embodiments in which database management process 216 monitors for the occurrence of event 262, database management process 216 may not delete collections of information 218, 220, and 222. Instead, database management process 216 may modify collections of information 218, 220, and 222 by moving data to another collection of information with a higher degree of relatedness than the collection of information presently associated with the text.

Additionally, database 212 may be located at a computer system other than computer system 204. In such an example embodiment, computer system 204 may communicate with database 212 over a network. In example embodiments in which database 212 contains hierarchy of collections of information 260, database management process 216 may associate collection of information 222 with collection of information 220 as a subordinate collection in hierarchy of collections of information when concept 242 is encompassed by concept 236. For example, concept 236 may be “medical professionals” and concept 242 may be “doctors.”

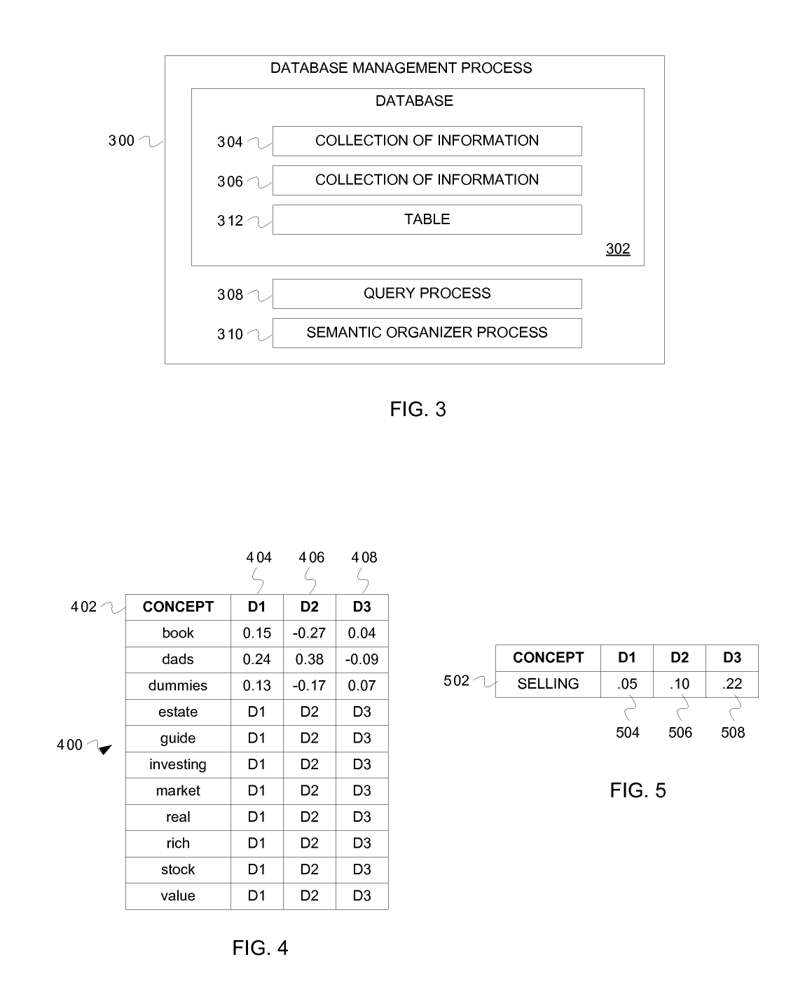

Turning now to FIG. 3, an illustration of a database management process is depicted in accordance with example embodiments. Database management process is an example implementation of database management process 216 in FIG. 2.

Database management process 300 contains database 302 in this example embodiment. Database 302 contains collection of information 304 and collection of information 306. In this example embodiment, database management process also runs query process 308 in response to receiving a request for data in database 302. More specifically, database management process 300 receives a request for data in database 302 and runs query process 308 to locate the records in database 302 that match the query.

Database management process 300 also runs semantic organizer process 310. Semantic organizer process 310 generates collections of information 304 and 306 from table 312 in database 302 responsive to an occurrence of an event, such as event 262 in FIG. 2. In some embodiments, the collection of information is generated from the media objects based on their tags or other inferred textual meaning For example, segments/frames of a video may generate multiple tags/text based on the content of the video and may change thru the video. Semantic organizer process 310 performs a latent semantic analysis on the concepts generated for the text in table 312. Semantic organizer process 310 then identifies collections of information 304 and 306 that meet or exceed a particular degree of relatedness configured in database management process 300, such as degree of relatedness 256. Semantic organizer process 310 then associates the text with the collection of information that meets or exceeds the particular degree of relatedness.

Referring now to FIG. 4, an illustration of a collection of information is depicted in accordance with an example embodiment. Collection of information 400 is an example implementation of collection of information 218 in FIG. 2. In these examples, collection of information 400 takes the form of a table in a database.

Collection of information 400 contains concept column 402, first dimension column 404, second dimension column 406, and third dimension column 408. Concept column 402 contains the concepts in collection of textual information 400. Concept column 402 is an example implementation of concept 230 in FIG. 2. In this illustrative example, collection of information 400 may be represented with a single concept or multiple concepts from concept column 402. A weighting algorithm may be used on the values in concept column 402 to determine a priority for concepts that may be used to represent the contents of collection of information 400.

The values in first dimension column 404, second dimension column 406, and third dimension column 408 represent values generated by performing a latent semantic analysis on the concepts in concept column 402. In this illustrative example, collection of information 400 was generated by performing a latent semantic analysis on one or more tables in the database that contain the terms to be processed. A matrix is generated that contains values for the number of times each of the terms appeared in the table. In these examples, the values are calculated using term frequency-inverse document frequency. Term frequency-inverse document frequency (TFIDF) is a weighting formula defined as the following:

TFIDFi,j=(Ni,j/N*,j)*log(D/Di),

where Ni,j is the number of times word I appears in table j, N*,j is the number of total words in the table j, D is the number of tables, and Di is the number of tables in which word i appears.

The matrix is then processed using single value decomposition (SVD) to reduce the dimensional representation of the matrix and reduce noise. In one example embodiment, the single value decomposition of the matrix is performed by making a function call to a library routine for generating SVD values. Performing the SVD calculation on the matrix generates the values in first dimension column 404, second dimension column 406, and third dimension column 408.

Turning now to FIG. 5, an illustration of a concept with a singular value decomposition is depicted in accordance with an example embodiment. Concept 502 is an example implementation of concept 215 in FIG. 2. Concept 502 is a concept representing text to be stored in the database containing table 400.

A latent semantic analysis is performed on concept 502 to generate first dimension value 504, second dimension value 506, and third dimension value 508. A degree of relatedness between concept 502 and one or more concepts in table 400 is identified. In this illustrative example, third dimension value 508 is compared with the value in third dimension column 408 for the first concept in concept column 402, that is, “book.” If the difference between the third dimension values is less than 0.25 (a threshold value that is determined by an administrator), the concepts are designated as related. Of course, in other example embodiments, first and/or second and/or third dimension values may be compared to determine whether the concepts are related.

Additionally, values for concept 502 may be compared to multiple concepts in table 400. In such example embodiments, concept 502 may be designated as related to the concepts in table 400 when the average difference between second dimension value 506 and the values in second dimension column 406 is less than a particular value. Of course, any suitable condition may be used to determine whether the concepts are to be designated as related.

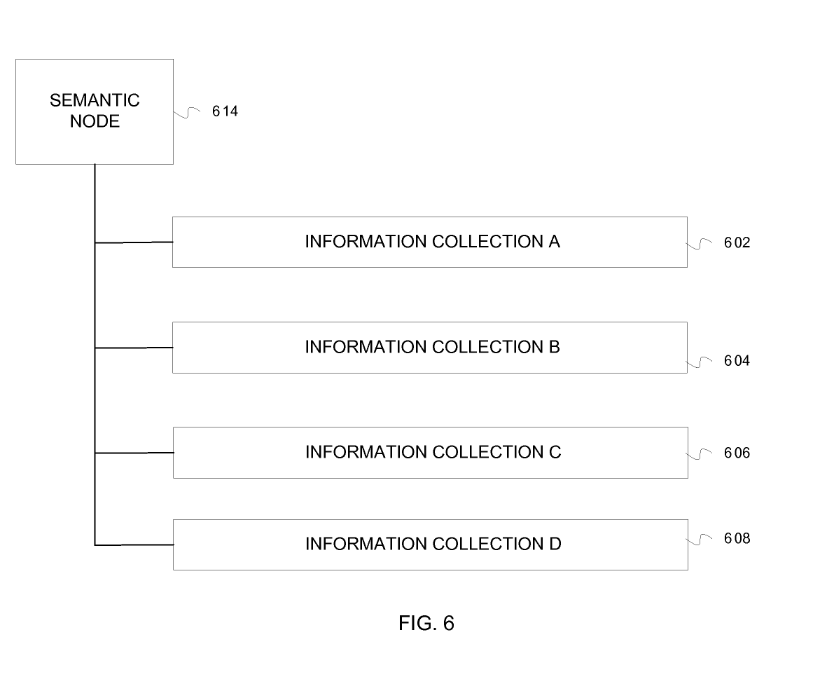

FIGS. 6-9 are diagrams illustrating various relationships between concepts, topics and textual content within semantic groupings. FIG. 6 illustrates collections of information 602, 604, 606 and 608 associated with a database table on a semantic node 614. Semantic node 614 is a physical computing node in a distributed database. Information related to one or more semantic groups may be stored on a semantic node of the distributed database. In the example illustrated in FIG. 6, semantic node 614 maintains collections of information 602, 604, 606 and 608. These collections are generated based upon LSA, requiring some level of computation.

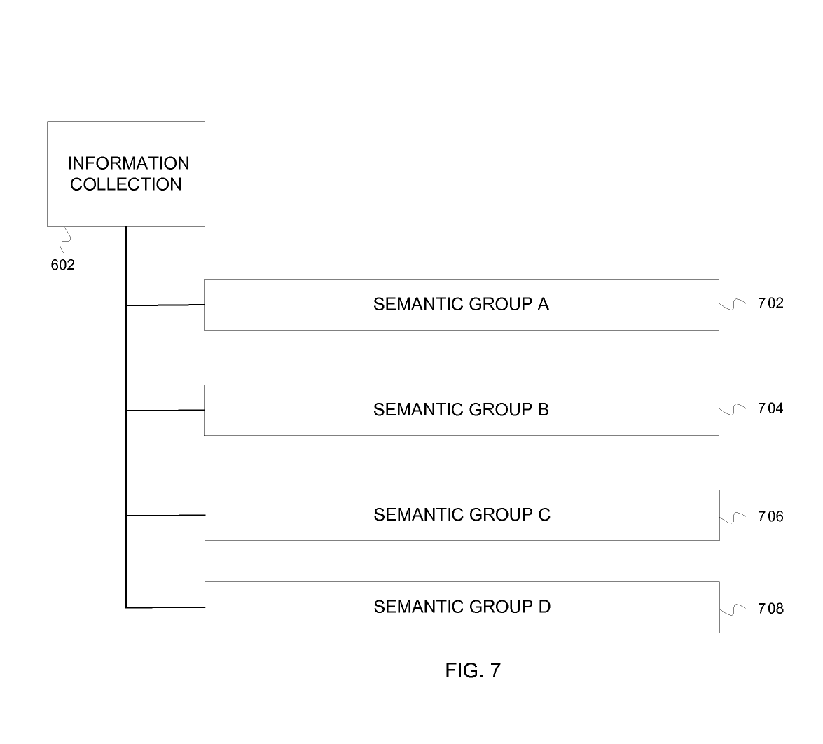

FIG. 7 illustrates the placement of collections of information in one or more semantic groups. As discussed above, a semantic group consists of a concept, and associated topic. A collection of information may be associated with more than one semantic group. In the example, illustrated in FIG. 7, information collection 602 is associated with four semantic groups 702, 704, 706 and 708.

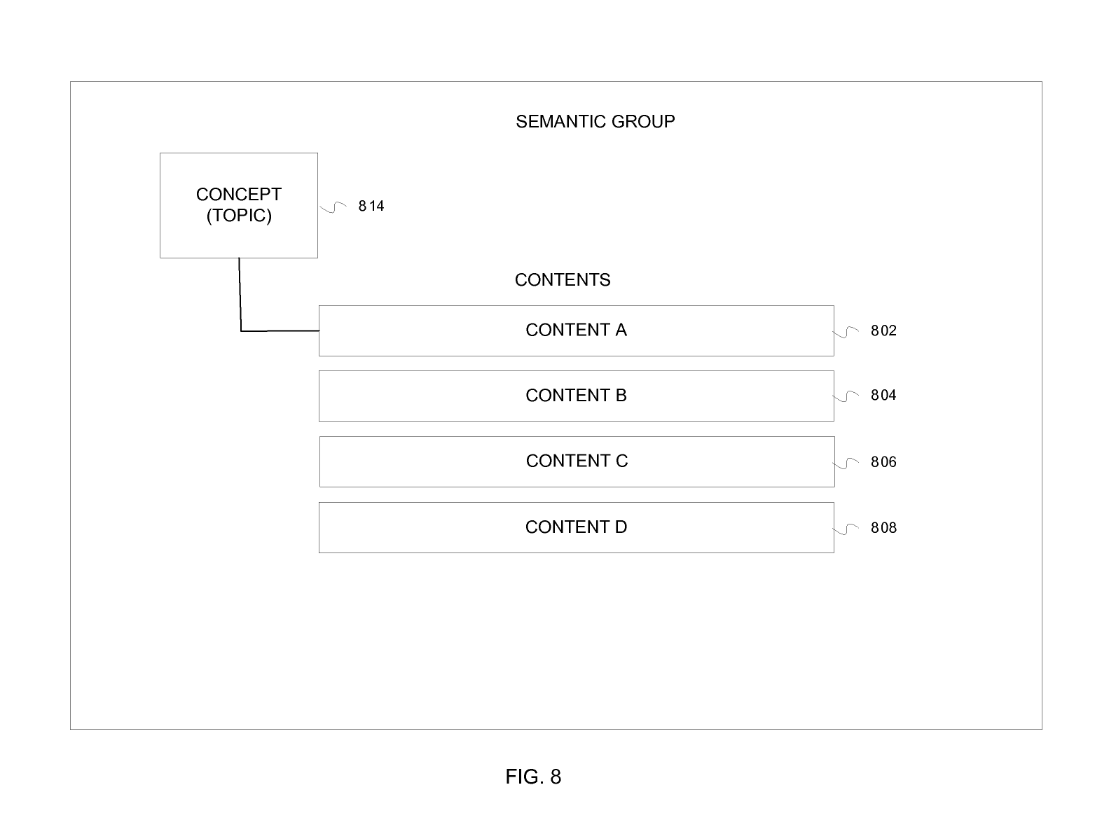

FIG. 8 illustrates the association of a concept 814 with content 802, 804, 806 and 808. As noted above, a concept generally describes the idea that relates contents 814 of a semantic grouping. In the example illustrated in FIG. 8, concept 814 may be “colors” when contents 802 contains “orange”, content 804 contains “blue”, content 806 contains “red”, and content 808 contains “green.” There may be one or more concepts associated with a semantic grouping, with each concept associated with a collection of content.

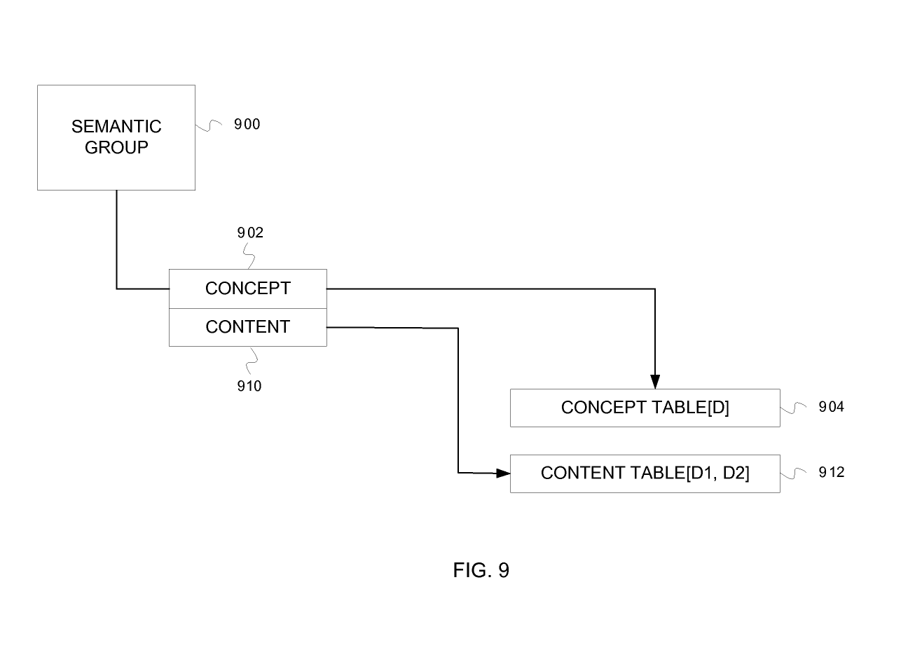

FIG. 9 illustrates a structure that may be used to represent a semantic group 900. Concept pointer 902 and content pointer 904 link semantic group 900 to concept structure 904 and content structure 912. Each of these structures may be represented by a table a single or multi-dimensional table of entries.

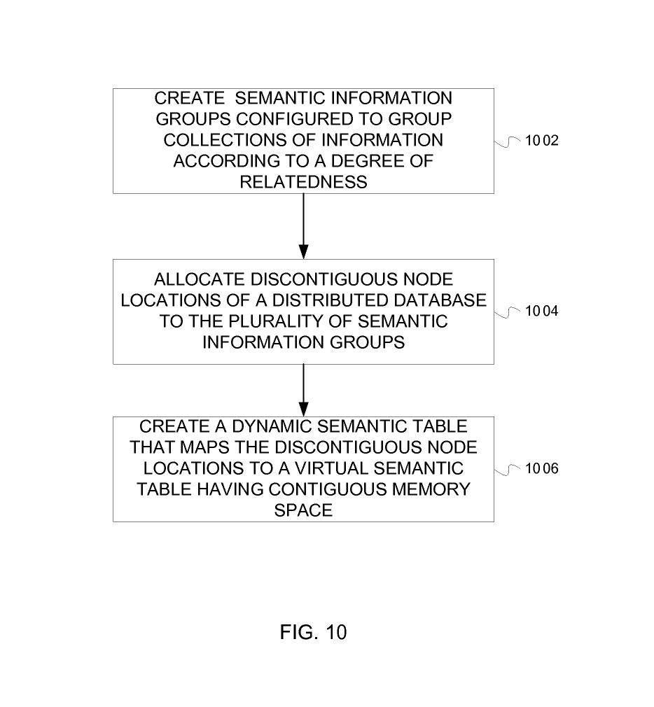

FIG. 10 is a flowchart that illustrates a method 1000 for mapping discontiguous node locations to contiguous memory locations according to embodiments. The method begins at block 1002 by creating semantic information groups according to a degree of relatedness. The semantic groups are created using the methodology described above in FIGS. 1-9.

At block 1004, database management process 216 allocates the semantic groups created at block 902 to discontiguous node locations. In some embodiments, the discontiguous node locations are physical nodes of a distributed database. As noted above, a physical node storing a semantic group may be referred to as a semantic node. In alternative embodiments, the discontiguous node locations may be discontiguous memory locations on a single physical node.

At block 1006, a mapping unit creates or updates a dynamic semantic table that maps the discontiguous node locations to a contiguous memory space. The dynamic semantic table map is used to map virtual semantic groups stored in consecutive virtual locations to physical locations. In some embodiments, the dynamic virtual semantic table can be represented by a sequential list of collections of textual information, which in turn connects a number of semantic groupings together. The virtual semantic table map does the translations between the virtual list of entries and the physical location of the entries. The mapping may be based on the concept or concept structures, semantic grouping structure, the collection of textual information structure or some other similar structure. In some embodiments, entities are mapped to a physical memory location based on various combinations of one or more of the following:
availability of physical location resources (e.g., memory availability)
minimum time needed to access physical entity (in terms of response time, network bandwidth, etc.)
proximity to computational engines used in calculating LSA and SVD
minimum power needed to store and access entity
potential types of accesses to entity, based upon types of events used in reconfiguring the dynamic database (e.g., period of time event, amount of data event, number of transactions event, etc.)
degree of relatedness among the entities among the contents or concepts in the semantic groupings.

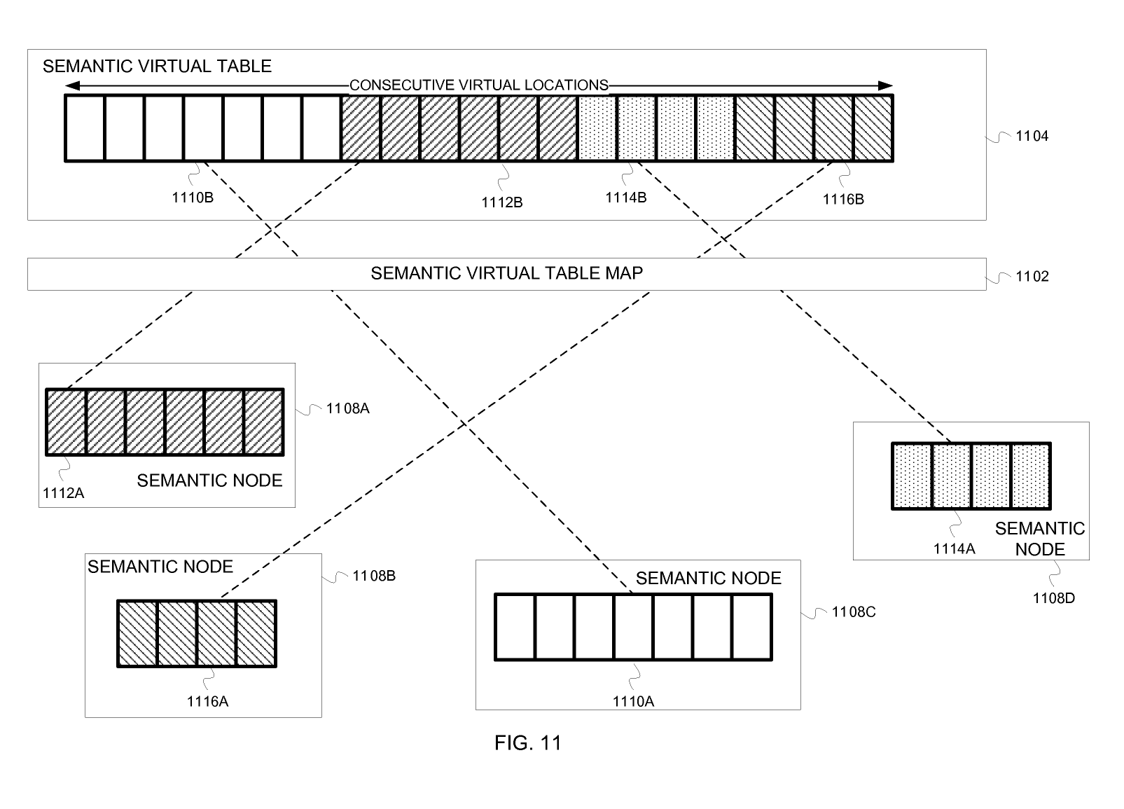

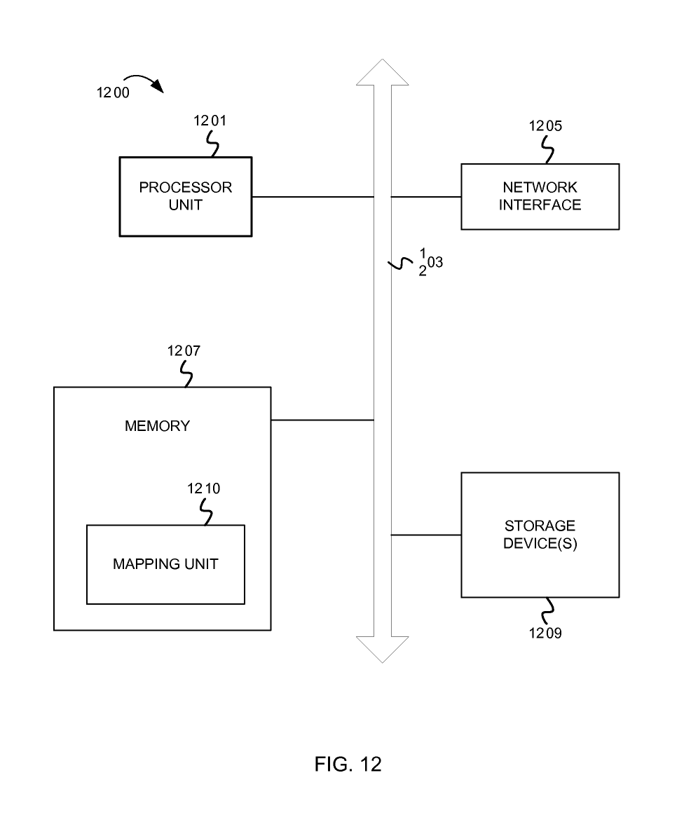

FIG. 11 is a block diagram illustrating the mapping provided by method 900 described above. In the example provided in FIG. 11, various semantic nodes 1108 maintain entries 1110A. 1112A. 1114A and 1116A comprising collections of information. Semantic virtual table map 1102 maps the entries stored in the various semantic nodes 1108 to virtual semantic table 1104. Virtual semantic table 1104 comprises a virtual list of entries. In the example shown in FIG. 11, virtual semantic table 1102 maps entries 1110A. 1112A. 1114A and 1116A to semantic virtual table entries 1110B, 1112B. 1114B and 1116B. This sequential collection of virtual entries maps may not map directly to a sequential list of physical entries.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 12 depicts an example computer system. A computer system includes a processor unit 1201 (possibly including multiple processors, multiple cores, multiple nodes, and/or implementing multi-threading, etc.). The computer system includes memory 1207. The memory 1207 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 1203 (e.g., PCI, ISA, PCI-Express, HyperTransport®, InfiniBand®, NuBus, etc.), a network interface 1205 (e.g., an ATM interface, an Ethernet interface, a Frame Relay interface, SONET interface, wireless interface, etc.), and a storage device(s) 1209 (e.g., optical storage, magnetic storage, etc.). The system memory 1207 embodies functionality to implement embodiments described above. The system memory 1207 may include mapping unit 1210 that facilitates mapping discontiguous node locations for semantic groups to contiguous memory locations as described above. Any one of these functionalities may be partially (or entirely) implemented in hardware and/or on the processing unit 1201. For example, the functionality may be implemented with an application specific integrated circuit, in logic implemented in the processing unit 1201, in a co-processor on a peripheral device or card, etc. Further, realizations may include fewer or additional components not illustrated in FIG. 12 (e.g., video cards, audio cards, additional network interfaces, peripheral devices, etc.). The processor unit 1201, the storage device(s) 1209, and the network interface 1205 are coupled to the bus 1203. Although illustrated as being coupled to the bus 1203, the memory 1207 may be coupled to the processor unit 1201.

While the embodiments are described with reference to various implementations and exploitations, it will be understood that these embodiments are illustrative and that the scope of the inventive subject matter is not limited to them. In general, techniques for using a dynamic semantic table to map discontiguous node locations to contiguous memory locations as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
creating, by one or more processors, a plurality of semantic information groups, the semantic information groups configured to group collections of information according to a degree of relatedness;
allocating discontiguous node locations of one or more distributed databases to the plurality of semantic information groups; and
creating a dynamic semantic table that maps the discontiguous node locations to a semantic virtual table having a contiguous memory space.

2. The method of claim 1, wherein creating the dynamic semantic table map creates the dynamic semantic table map in accordance with an availability of physical location resources.

3. The method of claim 1, wherein creating the dynamic semantic table map creates the dynamic semantic table map in accordance minimum time needed to access a node location.

4. The method of claim 1, wherein creating the dynamic semantic table map creates the dynamic semantic table map in accordance with proximity to computational engines used in performing LSA or calculating an SVD.

5. The method of claim 1, wherein creating the dynamic semantic table map creates the dynamic semantic table map in accordance a minimum power needed to store or access a mapped entity.

6. The method of claim 1, wherein creating the dynamic semantic table map creates the dynamic semantic table map in accordance with a type of reconfiguration event.

7. The method of claim 6, wherein the reconfiguration event includes one or more of a period of time event, amount of data event, or a number of transactions event.

8. The method of claim 1, wherein creating the dynamic semantic table map creates the dynamic semantic table map in accordance with a degree of relatedness among one or more of the mapped entities, contents or concepts in the semantic groupings.

9. The method of claim 1, wherein the semantic information groups include non-text data, and wherein creating a plurality of semantic information groups includes:
receiving text data associated with the non-text data; and
semantically analyzing the text data to determine a semantic information group to store the non-text data.

10. The method of claim 9, wherein the text data is derived from the non-text data.

11. A method comprising:
receiving text data associated with non-text data;
creating, by one or more processors, a plurality of semantic information groups, the semantic information groups configured to group collections of information according to a degree of relatedness based on the text data associated with the non-text data;
allocating discontiguous node locations of one or more distributed databases to the plurality of semantic information groups; and
creating a dynamic semantic table that maps the discontiguous node locations to a semantic virtual table having a contiguous memory space.

12. The method of claim 11, wherein the text data comprises one or more of tags associated with the non-text data or data derived from the non-text data by processing the non-text data.

13. A computer program product for managing collections of information, the computer program product comprising:
a computer readable storage medium having computer usable program code embodied therewith, the computer usable program code comprising a computer usable program code configured to:
create a plurality of semantic information groups, the semantic information groups configured to group collections of information according to a degree of relatedness;
allocate discontiguous node locations of one or more distributed databases to the plurality of semantic information groups; and
create a dynamic semantic table that maps the discontiguous node locations to a semantic virtual table having a contiguous memory space.

14. The computer program product of claim 13, wherein the computer usable program code configured to create the dynamic semantic table map includes computer usable program code configured to create the dynamic semantic table map in accordance with a degree of relatedness among one or more of the mapped entities, contents or concepts in the semantic groupings.

15. The computer program product of claim 13, wherein the semantic information groups include non-text data, and wherein the computer usable program code configured to create a plurality of semantic information groups includes computer usable program code configured to:
receive text data associated with the non-text data; and
semantically analyze the text data to determine a semantic information group to store the non-text data.

16. An apparatus comprising:
one or more processors; and
a computer readable storage medium having computer usable program code embodied therewith, the computer usable program code comprising a computer usable program code configured to cause the one or more processors to:
create a plurality of semantic information groups, the semantic information groups configured to group collections of information according to a degree of relatedness;
allocate discontiguous node locations of one or more distributed databases to the plurality of semantic information groups; and
create a dynamic semantic table that maps the discontiguous node locations to a semantic virtual table having a contiguous memory space.

17. The apparatus of claim 16, wherein the discontiguous node locations include node locations on two or more communicably coupled computing systems.

18. The apparatus of claim 16, wherein the computer usable program code configured to create the dynamic semantic table map includes computer usable program code configured to create the dynamic semantic table map in accordance with an availability of physical location resources.

19. The apparatus of claim 16, wherein the computer usable program code configured to create the dynamic semantic table map includes computer usable program code configured to create the dynamic semantic table map in accordance minimum time needed to access a node location.

20. The apparatus of claim 16, wherein the computer usable program code configured to create the dynamic semantic table map includes computer usable program code configured to create the dynamic semantic table map in accordance with proximity to computational engines used in performing LSA or calculating an SVD.

21. The apparatus of claim 16, wherein the computer usable program code configured to create the dynamic semantic table map includes computer usable program code configured to create the dynamic semantic table map in accordance a minimum power needed to store or access a mapped entity.

22. The apparatus of claim 16, wherein the computer usable program code configured to create the dynamic semantic table map includes computer usable program code configured to create the dynamic semantic table map in accordance with a type of reconfiguration event.

23. The apparatus of claim 16, wherein the reconfiguration event includes one or more of a period of time event, amount of data event, or a number of transactions event.

24. The apparatus of claim 16, wherein the computer usable program code configured to create the dynamic semantic table map includes computer usable program code configured to create the dynamic semantic table map in accordance with a degree of relatedness among one or more of the mapped entities, contents or concepts in the semantic groupings.

25. The apparatus of claim 16, wherein the semantic information groups include non-text data, and wherein computer usable program code configured to create the plurality of semantic information groups includes computer usable program code configured to:
receive text data associated with the non-text data; and
semantically analyze the text data to determine a semantic information group to store the non-text data.
